(19) United States
(12) Patent Application Publication
(10) Pub. No.: US 2009/0152976 A1
(43) Pub. Date: Jun. 18, 2009

(54) DYNAMO-ELECTRICAL MACHINE WITH TOOTH-WOUND COILS

(75) Inventors: Erich Bott, Hollstadt (DE); Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/333,959

(22) Filed: Dec. 12, 2008

(30) Foreign Application Priority Data
Dec. 13, 2007 (EP) EP07024228

(51) Int. Cl. H02K 3/493

(52) U.S. Cl. 310/214; 310/216.098

(57) ABSTRACT

A dynamo-electrical machine includes a stator with teeth which are aligned with respect to a rotor, wherein at least a predeterminable number of teeth are surrounded by a winding system which is arranged in slots. The slots which are formed by the teeth and designed to be open, are each closed by a slot sealing element which has an electrically non-conductive and magnetically non-permeable material in which a tooth head widening element is provided in the area of those tooth sections of the tooth heads which face the air gap.

### CROSS-REFERENCES TO RELATED APPLICATIONS

This application claims the priority of European Patent Application, Serial No. 07024228, filed Dec. 13, 2007, pursuant to 35 U.S.C. 119(a)-(d), the content of which is incorporated herein by reference in its entirety as if fully set forth herein.

### BACKGROUND OF THE INVENTION

The present invention relates, in general, to a dynamo-electrical machine.

Teeth of stators of dynamo-electrical machines normally have tooth heads which, in particular, are wider than a tooth shank. They are used to make the magnetic flux in the air gap of the dynamo-electrical machine uniform, and this has an advantageous effect on the characteristic data and function of the dynamo-electrical machines. In particular, the widened tooth heads make it harder, however, to introduce the winding using known processes such as pulling-in technique, or by means of needle winders, into the stator slots which are located between the teeth, and in the end this results in a comparatively low copper filling level, involving a large amount of effort, in the slots.

Production could be simplified when the tooth of a stator can be constructed without tooth head, i.e. not to be widened in the area of the air gap in comparison to its shank, because preformed or prefabricated coils, for example tooth-wound coils, can then be introduced relatively easily into the slot, from the stator bore of an internal rotor. Although this would in better copper filling, the flux guidance across the air gap to the rotor becomes inadequate. The use of slot seals composed of plastic with a predeterminable permeability have been proposed but the outcome was unsatisfactory.

Another approach to achieve a sufficiently high copper filling involves a two-part configuration of a stator, i.e. the stator is comprised of a tooth pack and a yoke rear, into which the wound tooth pack is inserted after the winding process and an optional encapsulation process.

German Pat. No. DD 52 614 discloses a method for production of magnetically permeable slot sealing wedges for winding slots in electrical machines, wherein the slot sealing wedges comprise iron, in the form of powder, cast with plastics.

It would therefore be desirable and advantageous to provide an improved dynamo-electrical machine to obviate prior art shortcomings and to provide a flux guidance to the rotor with open slots in a same way as in the case of a closed slot, while yet allowing a high copper filling level in the slots.

### SUMMARY OF THE INVENTION

According to one aspect of the present invention, a dynamo-electrical machine, includes a rotor, and a stator having plural teeth aligned with respect to the rotor, each tooth terminating in a tooth head, wherein the teeth define slots there between which are open, wherein at least a predeterminable number of teeth are surrounded by a winding system which is arranged in the slots, with each slot being closed by a slot sealing element which includes an electrically non-conductive and magnetically non-permeable material and a tooth head widening element which is provided in an area of an air-gap proximal tooth section of the tooth head and is laminated or sintered, or configured in the form of litz wires composed of insulated filaments.

According to another aspect of the present invention, a method for producing a slot seal includes the steps of producing a tooth head widening element, and positioning the tooth head widening element in plastic.

According to yet another aspect of the present invention, a method for the production of a stator of a dynamo-electrical machine includes the steps of interlocking laminates of the stator by stamping and stacking to form a laminated core, inserting a winding system in slots of the laminated core, inserting a slot sealing element in the form of a tooth head widening element embedded in plastic in each slot.

The slots are now each sealed by a slot sealing element according to the invention, which contains the tooth head widening elements. The slot seal is formed mainly from an electrical magnetically non-permeable material, preferably from plastic. The tooth head widening elements are now integrated in this plastic. These tooth head widening elements are preferably soft-magnetic materials, for example in laminated form, in the form of litz wires, or in the form of magnetically permeable particles, which are now connected to the plastic.

The connection to the plastic can be carried out, for example, by means of an interlock by tooth head widening elements being inserted into a plastic tool, where they are extrusion-coated. The slot seals obtained in this way, which are now composed of a plastic compound and the tooth head widening elements, are inserted into the open slots.

The insertion process may be carried out, for example, by means of snap-action connections or by pushing axially into the slot. This additionally presses the conductors of the winding together, thus also increasing the copper filling factor in the slot.

The laminated tooth head widening elements may be produced by stamping-packeting or are formed by stove-enamel joints between the individual laminates.

The tooth head widening elements are thus formed from individual laminates arranged axially one behind the other or from soft-magnetic litz wires, which preferably have insulated filaments. Slot seals in the form of strands can now be produced by means of an injection-molding process with inserted tooth widening elements, or by means of an extrusion process.

The extrusion process is particularly suitable for tooth head widening elements in the form of litz wires, since both the litz wires and the plastic can be produced in one process.

The slot seals according to the invention have a positive influence on the flux guidance in the area of the slot opening, i.e. the abrupt transitions between the areas of the air gap between the tooth and the open slot are made uniform by the tooth head widening elements. From the magnetic point of view, there are therefore also no completely closed slot seals, which could lead to scatter effects.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a laminated stator core with tooth-wound coil windings;

FIG. 2 is an enlarged detailed view of the area of the stator core encircled in FIG. 1;

FIG. 3 is a perspective view of a tooth head widening element;

FIG. 4 is a schematic plan view of the tooth head widening element;

FIG. 5 is a schematic plan view of a modified tooth head widening element; and

FIG. 6 is an enlarged detailed view of the area of the tooth head widening element encircled in FIG. 5 and marked VI.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

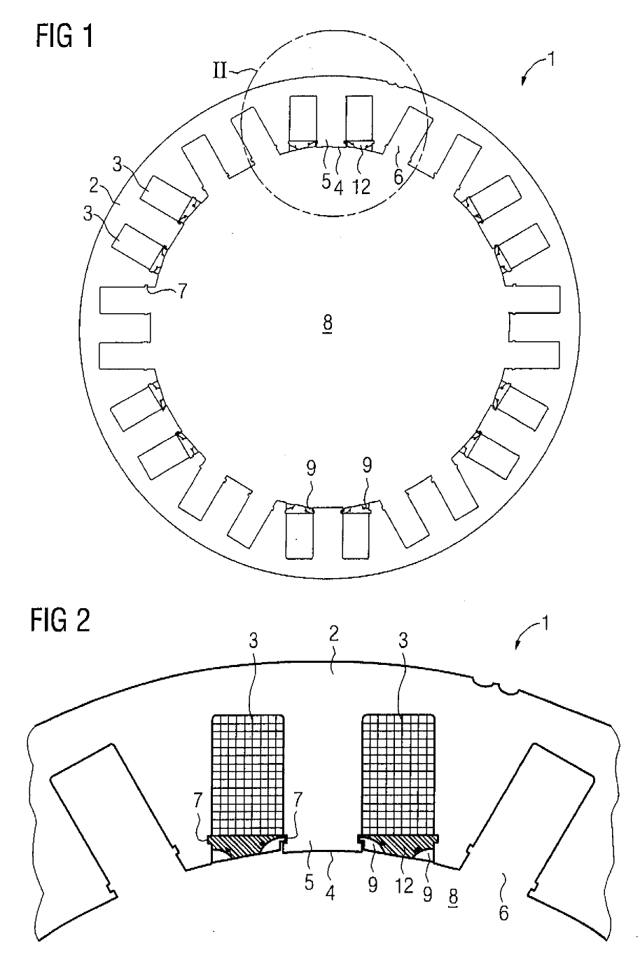

Turning now to the drawing, and in particular to FIG. 1, there is shown a schematic illustration of a laminated stator core, generally designated by reference numeral 1 and made of laminates 2, of which only one is shown here. The laminate 2 has various tooth shapes, wherein a tooth with a tooth shank 5 and a tooth head 4 of the same width are each surrounded by a tooth-wound coil 3. The tooth shank 5 is thereby formed by parallel slot walls. Only every other tooth is therefore surrounded by a tooth-wound coil 3, with the tooth-wound coil 3 being located in slots 6 with parallel slot walls. The tooth, which tapers in the direction of the air gap of the dynamo-electrical machine, is in this case not surrounded by tooth-wound coils 3. The slot seal which is illustrated in principle in a number of slots 6 is now composed of an electrically non-conductive and magnetically non-permeable material, in particular plastic 12, and tooth head widening elements 9 inserted in the plastic 12.

The tooth head widening elements 9 are in this case positioned via interlocking elements 10 in the plastic 12 and/or by means of tabs 11 in recesses 7 in the tooth shank 5 of the wound or unwound tooth, as is shown in the detailed illustration in FIG. 2.

In the embodiment described above, only every other tooth is surrounded by a tooth-wound coil 3, i.e. only one coil side of one tooth-wound coil 3 is located in one slot 6. However, the invention is also applicable to other winding systems, for example traditional fractional-chord windings, in which the winding process is considerably simplified because the slots 6 are open.

In principle, the slot seal according to the invention and as described above creates extremely advantageous electromagnetic conditions which result in the dynamo-electrical machine having a comparatively greater torque output.

The tooth head widening elements 9 are embedded in the plastic 12 to realize a uniform stator bore radius in the direction of the air gap of the dynamo-electrical machine. The stator bore is therefore essentially round, as a result of which there are also no steps in the area of the slots themselves. This makes the profile of the magnetic flux density in the air gap of the dynamo-electrical machine uniform, thus further reducing cogging torques.

Particularly in the case of a laminate section as shown in FIG. 1, in which every alternate tooth is surrounded by a tooth-wound coil 3, and in which the slots 6 which surround this tooth, are aligned parallel, when considered radially, the tooth head widening elements 9 of a slot 6 are designed to be different, for matching to the round profile of the stator bore.

The tooth head widening elements 9 improve the flux guidance in the area of the tooth head 4. The scatter losses are considerably reduced because of the plastic 12 between the teeth and between the tooth head widening elements 9. Furthermore, the assembly process is simplified, in particular for the tooth-wound coils onto their respective teeth from the direction of the stator bore.

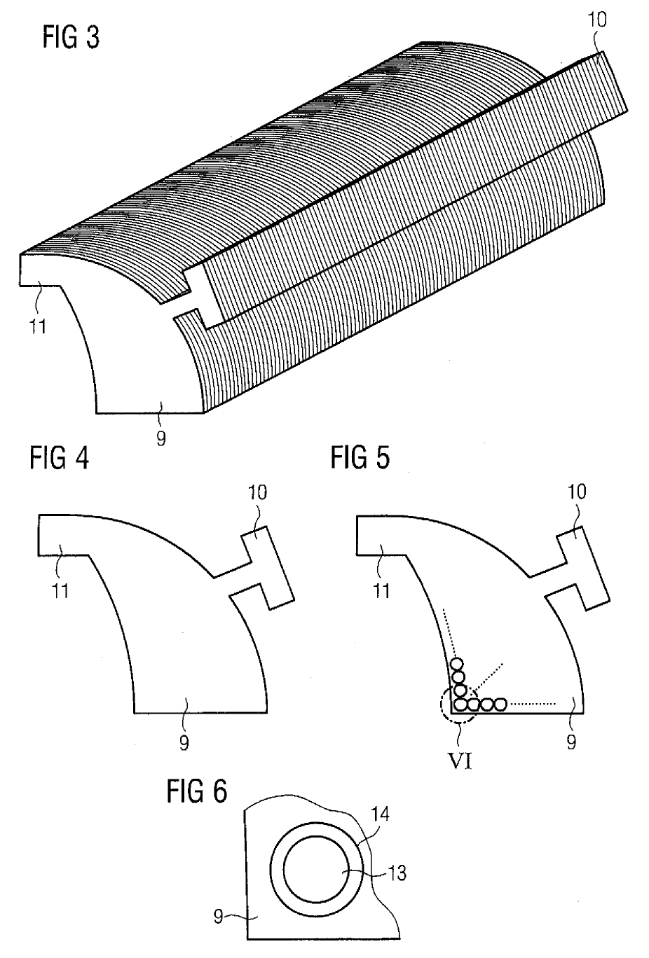

FIG. 3 shows an outline illustration of a tooth head widening element 9, having an axial extent which advantageously corresponds to the length of a slot, that is to say approximately to the axial length of the stator 1. The tooth head widening element 9 can also be assembled by means of individual axial subelements to match the axial length of the slot 6.

The tooth head widening element 9 in principle has means in order to be positioned and/or fixed in the plastic 12 and/or the tooth shank 5. Interlocking elements 10 and/or tabs 11 are advantageously provided for this purpose, by means of which the tooth head widening element 9 is positioned in the laminate 2 of the laminated core of the stator 1, that is to say the tooth shank 5 and/or in the plastic 12 of the slot seal.

The outline illustration also shows that the tooth widening element 9 as shown in FIG. 3 is laminated, and this is done, inter alia, by stamping-packeting. In this case, the individual laminates are connected in the stamping tool by means of stamping studs. As an alternative to this, the individual laminates are joined together by stove enamel, with the individual laminates coated with stove enamel being adhesively bonded with axial pressure being applied under the influence of a predetermined temperature. The lamination of the tooth head widening elements 9 also reduces the eddy current losses in the tooth head widening elements 9.

The tooth head widening elements 9 are part of the slot seal, by virtue of an injection-molding process or by virtue of an extrusion process. The tooth head widening elements 9 are in this case either laminated or are formed by pressed litz wires which surround each of the magnetically permeable filaments with insulation 14 as shown in FIGS. 5, 6. This also reduces the eddy current losses in the tooth head widening elements 9.

In a further refinement, the tooth head widening elements 9 are formed from magnetically permeable particles whose size extends from a few millimeters down to the nanometer range, depending on the machine size. These particles are preferably baked in a carrier material, for example plastic.

After the winding 3 has been inserted into the laminated core of the stator 1, the slot sealing elements, which comprise tooth head widening elements 9 and a plastic 12, are now inserted, thus resulting in advantageous flux guidance in the area of the air gap 8 of a dynamo-electrical machine which is not illustrated in any more detail. In this case, the rotor now remains comparatively cool during operation of the dynamo-electrical machine, as a result of which this machine can output a greater torque because the current in the tooth-wound coils 3 is now greater.

The embodiment according to the invention of the slots by means of the tooth head widening elements 9 positioned in the plastic 12 can be used not only in the case of a laminate section according to the exemplary embodiment shown in FIG. 1 but also in the case of a laminate section with identically formed teeth, when the slots 6 are arranged radially. In this case, the tooth head widening elements 9 can then be formed identically.

Furthermore, the idea according to the invention can also be implemented in dynamo-electrical machines in which two coil sides of a tooth-wound coil are located in each slot 6, that is to say with each tooth being surrounded by a tooth-wound coil.

The shape of the tooth head widening elements 9 is advantageously as shown in the figures, that is to say that the radial extent tapers in the direction of the center of the slot. This avoids magnetic saturation effects in the tooth head widening elements 9.

Other shapes are, of course, also feasible for the tooth head widening elements 9, provided that they likewise ensure fixing in the slot while at the same time avoiding saturation effects.

In addition to the refinements of the tooth head widening elements 9 as described above, the plastic 12 can also be provided with magnetically permeable particles. However, the density should be lower than that of the tooth head widening elements 9 since, otherwise, this would result in magnetic characteristics as in the case of a closed slot.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A dynamo-electrical machine, comprising:
a rotor; and
a stator having plural teeth aligned with respect to the rotor, each said tooth terminating in a tooth head, said teeth defining slots there between which are open, wherein at least a predeterminable number of teeth are surrounded by a winding system which is arranged in the slots, each said slot being closed by a slot sealing element which includes an electrically non-conductive and magnetically non-permeable material and a tooth head widening element which is provided in an area of an air-gap proximal tooth section of the tooth head and is laminated or sintered, or configured in the form of litz wires composed of insulated filaments.

2. The dynamo-electrical machine of claim 1, wherein the tooth head widening element is made of magnetic material.

3. The dynamo-electrical machine of claim 1, wherein the tooth head widening element is made of soft-magnetic material.

4. The dynamo-electrical machine of claim 1, wherein the tooth head widening element in the slot is connected to the electrically non-conductive and magnetically non-permeable material.

5. The dynamo-electrical machine of claim 1, wherein the tooth head widening element in the slot is connected by interlock to the electrically non-conductive and magnetically non-permeable material.

6. The dynamo-electrical machine of claim 1, wherein the tooth head widening element is made by an extrusion process from plastic and litz wire.

7. The dynamo-electrical machine of claim 1, wherein the tooth head widening element is made by an injection-molding process.

8. A method for producing a slot seal, comprising the steps of:
producing a tooth head widening element; and
positioning the tooth head widening element in plastic.

9. A method for the production of a stator of a dynamo-electrical machine, comprising the steps of:
interlocking laminates of the stator by stamping and stacking to form a laminated core;
inserting a winding system in slots of the laminated core;
inserting a slot sealing element in the form of a tooth head widening element embedded in plastic in each slot.
